(19) United States
(12) Patent Application Publication
(10) Pub. No.: US 2010/0270365 A1
(43) Pub. Date: Oct. 28, 2010

(54) SOLDER PASTE COMPOSITION HAVING SOLDER POWDER, FLUX AND METALLIC POWDER

(75) Inventors: Yoichi KUKIMOTO, Kakogawa-shi (JP); Kazuki Ikeda, Kakogawa-shi (JP); Hitoshi Sakurai, Kakogawa-shi (JP); Nobuhiro Kinoshita, Tokyo (JP); Masaki Nakanishi, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: Harima Chemicals, Inc., Kakogawa (JP); Renesas Technology Corp., Tokyo (JP)

(21) Appl. No.: 12/831,667

(22) Filed: Jul. 7, 2010

Related U.S. Application Data
(62) Division of application No. 12/038,404, filed on Feb. 27, 2008.

(30) Foreign Application Priority Data
May 28, 2007 (JP) 2007-140331

(51) Int. Cl. B23K 1/20

(52) U.S. Cl. 228/248.1

(57) ABSTRACT

The present invention relates to a solder paste composition used for precoating an electrode surface with solder. A first solder paste composition is contains a solder powder and a flux, and a metallic powder made by metallic species different from metallic species constituting the solder powder and metallic species constituting the electrode surface in a rate of 0.1% by weight or more and 20% by weight or less based on a total amount of the solder powder. When these solder paste compositions are evenly applied onto an electronic circuit substrate for precoating, such a solder that does not generate any swollen portion, solder-lacking portion and variability in a height thereof can be formed irrespective of a shape of a pad.

This is a divisional of application Ser. No. 12/038,404 filed Feb. 27, 2008. The entire disclosure of the prior application, application Ser. No. 12/038,404 is considered part of the disclosure of the accompanying divisional application and is hereby incorporated by reference.

### BACKGROUND OF THE INVENTION

1. Field of the Invention

The present invention relates to a solder paste composition which is suitable for evenly applying onto an electronic circuit substrate so that the substrate is precoated with solder in a stage before an electronic component such as a semiconductor chip is mounted thereon and use of the solder paste composition.

2. Description of the Related Art

As electronic devices, and the like, are increasingly miniaturized in recent years, a multilayer substrate in which a large number of electronic components are piled on one electronic circuit substrate is most often adopted. For example, a semiconductor device (semiconductor package) of the SIP type (System in Package), in which semiconductor chips of a plurality of different product classes are piled on the electronic circuit substrate, is currently attracting attention. An effective way of realizing the miniaturization in the case of the semiconductor device of the SIP type is to adopt the so-called flip-chip connection. Describing the flip-chip connection, the semiconductor chip mounted on a first stage (of all of the piled semiconductor chips, the semiconductor chip which is the closest to the electronic circuit substrate) is mounted so that a main surface thereof faces a main surface of the electronic circuit substrate, and a bump (protruding electrode) formed on the semiconductor chip and a bump (an electrode) provided on an electrode pad (bonding lead) are solder-connected.

A method conventionally adopted in the case of the flip-chip connection is to evenly apply the solder paste on the electronic circuit substrate (that is, to apply the solder paste on the entire surface area of the substrate including the electrodes) and heat the substrate so that surfaces of the respective electrodes are thereby precoated. The method is adopted because a large number of electrodes are now formed with small intervals therebetween in a narrow area on the electronic circuit substrate along with the miniaturization of the electronic devices and components, which significantly reduced a pitch at which the pad of the electronic circuit substrate is aligned (for example, approximately 60 to 80 μm). Accordingly, it becomes difficult to accurately print the solder paste on such a finely-pitched pad by means of the screen printing method which is conventionally adopted.

More specifically, when the electronic circuit substrate is precoated with the solder paste, the solder paste is supplied onto a plurality of pads provided in an opening of a solder resist (insulation film) and reflowed so that the solder layer is formed on the pad where the bump of the semiconductor chip is connected (bump connecting part). At the time, the pad can be designed to have a shape having a large-width section whose width is larger than other portions in apart thereof in a longitudinal direction, in other words, such a shape that a width dimension (W1) of a large-width section 1a is larger than a width dimension (W2) of other portions as in a pad 1 shown in FIG. 1. Further, the electrodes are provided in the large-width section 1a of the pad 1 provided between the solder resists 2. Then, the solder can precoat the electronic circuit substrate so that the large-width section 1a (that is, a bump connecting part) provided with the electrodes has such a shape that the center rises upward like a hump according to the surface tension of the solder as conventionally known.

An example of a solder paste composition used for the precoating method described above is the cream solder including cellulose by a predetermined percentage, which was proposed in Japanese unexamined patent publications No. 05-391. Another example is the cream solder using multiple particles obtained when lead or tin-lead alloy is applied to surfaces of tin particles as solder powder, which was proposed in Japanese unexamined patent publications No. 05-96396.

However, when the conventional solder paste compositions were used to preform the precoating method described above, various problems were unfavorably caused. More specifically: a swollen portion 3b is generated in a part other than the section which is supposed to have the hump shape (large-width section 1a) as shown in FIG. 2(a), as a result of which an amount of the solder necessary in a hump-shape portion 3a cannot be obtained due to the swollen portion 3b; a solder-lacking portion 4 is generated in part of a solder 3 as shown in FIG. 2(b); and a height of the solder is variable among a plurality of electrodes. Any of these disadvantages results in the deterioration of a yield, which makes it not possible to obtain a mounted substrate at a satisfactory level. FIG. 2 is a schematic sectional view showing a pattern of solder formed on a pad having such a shape as shown in FIG. 1 when an electronic circuit substrate provided with the pad is precoated with the solder.

In the case where a semiconductor chip is flip-chip-connected to the electronic circuit substrate, in general, under-fill resin is filled into between a main surface of the semiconductor chip and a main surface of the electronic circuit substrate so that they are not separated from each other at a part where they are connected to each other. The under-fill resin is conventionally supplied in such a manner that a supply nozzle is moved along a side surface (side) of the semiconductor chip after the semiconductor chip is mounted on the substrate. During the supply, however, in the case where an end portion 10′ of a semiconductor chip 10 and an end portion 11′ of an opening of an insulation film 11 substantially overlap with each other in a planar manner when the semiconductor chip 10 and an electronic circuit substrate 12 are positioned as shown in FIG. 3, an inlet of the under-fill resin (that is, gap in vicinity of the end portion of the semiconductor chip) is relatively narrowed. Therefore, it disadvantageously difficult to fill the under-fill resin so as to reach a central part of the main surface of the semiconductor chip.

In order to fill the under-fill resin in a more effective manner, as shown in FIG. 4, there was such a method conventionally adopted that the opening of the insulation film 11 was enlarged so as to prevent the end portion 10′ of the semiconductor chip 10 and the end portion 11′ of the opening of the insulation film 11 from planarly overlapping with each other, and an end 1′ of the pad 1 was extended so that a part of the pad 1 was exposed (in other words, the extended end 1′ of the pad 1 was located on an outer side of the substrate in comparison to the end portion 10′ of the semiconductor chip 10) in a region where the supply nozzle of the under-fill resin moved, as a result of which the inlet of the under-fill resin was enlarged. According to the method, an under-fill resin 17 supplied from a supply nozzle 14 can be smoothly filled from the inlet having an enough width to finally reach the central part as shown in FIG. 5.

In the case where the method of enlarging the inlet of the under-fill resin is adopted, the pad having the large-width section, as described above, has a shape that a length from one end in the longitudinal direction to the large-width section la (L1 in FIG. 6) and a length from the other end to the large-width section 1a (L3 in FIG. 6) are different from each other in the same manner as the pad 1 shown in FIG. 6.

However, when the pad having the shape in which the length from one end in the longitudinal direction to the large-width section and the length from the other end to the large-width section are different from each other is used, the problems described above, which are the generation of the swollen portion, solder-lacking portion and the variability of the height in the precoated solder, are often even more remarkable. More specifically, in the case where the lengths of L1 and L3 are substantially equal to each other as in the pad 1 shown in FIG. 7 (in other words, the large-width section 1a is formed at substantially the center of the opening of the insulation film 11 in a direction where the pad 1 extends), for example, a stress is concentrated on the center of the pad. Accordingly, the solder paste is converged on the large-width section 1a provided at the center, which allows the formation of such a shape that the center rises upward in the hump shape. However, in the case where the lengths of L1 and L3 are different from each other as in the pad 1 shown in FIG. 6, the stress generated in the pad fails to focus on the center, and the solder paste is thereby converged on positions other than the large-width section 1a. When the solder paste fails to converge on the large-width section 1a, it becomes difficult for the solder paste to be supplied to the protruding electrodes in the case of the flip-chip connection. As a result, defect in the mounting process of the semiconductor chip may be caused.

### SUMMARY OF THE INVENTION

Therefore, a main object of the present invention is to provide a solder paste composition capable of forming solder which does not generate any swollen portion, solder-lacking portion and variability in a height of the solder irrespective of a shape of a pad when evenly applied onto an electronic circuit substrate so that the substrate is coated by the solder, and a precoating method and a mounted substrate in which the solder is used.

The inventors of the present invention repeated intensive studies in order to achieve the above-described object; as a result, they found out that the above-described object could be achieved at once when a specific amount of metallic powder obtained from metallic species different from metallic species constituting solder powder or a deposition solder material and metallic species constituting an electrode surface was included, and completed the present invention.

A first solder paste composition according to the present invention is a solder paste composition used when an electrode surface is precoated with the solder, which contains a solder powder and a flux, and a metallic powder made by metallic species different from metallic species constituting the solder powder and metallic species constituting the electrode surface in a rate of 0.1% by weight or more and 20% by weight or less based on a total amount of the solder powder.

A second solder paste composition according to the present invention is a solder paste composition used when the electrode surface is precoated with the solder, which contains a deposition solder material which deposits the solder when heated and a flux, and a metallic powder obtained from metallic species different from metallic species constituting a metallic component in the deposition solder material and metallic species constituting the electrode surface in a rate of 0.1% by weight or more and 20% by weight based or less on a total amount of the metallic component in the deposition solder material.

In the precoating method according to the present invention, the solder paste composition is applied onto an electronic circuit substrate provided with a pad having a large-width section whose width is larger than other portions in apart thereof in a longitudinal direction and thereafter heated so that a surface of an electrode provided in the large-width section of the pad is precoated with the solder. In the precoating method, the first solder paste composition or the second solder paste composition according to the present invention is used as the solder paste composition.

In the mounted substrate according to the present invention, an electronic component mounted on an electronic circuit substrate is thermally compression-bonded thereto by the precoated solder in which the first solder paste composition or the second solder paste composition according to the present invention is used.

According to the present invention, when the solder paste composition is evenly applied to the electronic circuit substrate for precoating, the solder can be formed without any swollen portion, solder-lacking portion and variability in a height of the solder irrespective of a shape of the pad, which improves a yield. Further, when the electronic component is flip-chip-connected to the electronic circuit substrate by means of the solder, not only the solder can be formed without the generation of any swollen portion, solder-lacking portion and variability in the height of the solder, but also the filling of the under-fill resin can be effectively secured.

Other objects and advantages of the present invention will be made clear in the following description.

### BRIEF DESCRIPTION OF THE DRAWINGS

FIG. 1 is a schematic plan view of an electronic circuit substrate for describing a precoating method in which a solder paste composition is used according to one embodiment of the present invention.

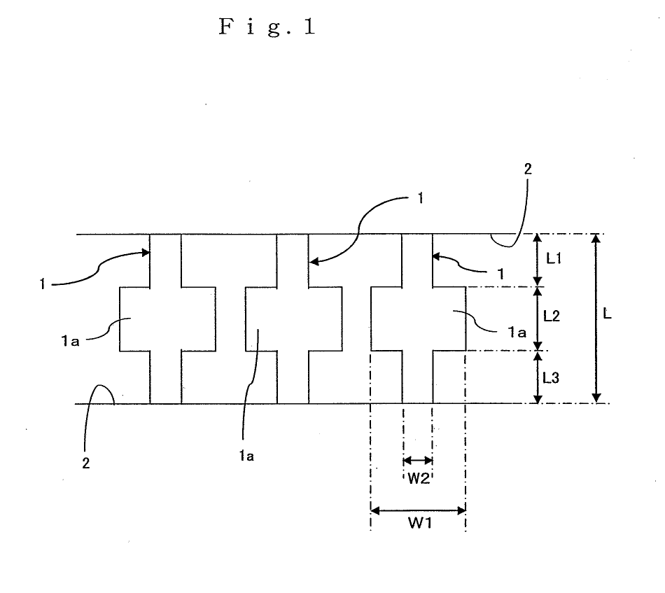

FIG. 2 is a schematic sectional view of a precoating solder for describing the conventional problems when the solder paste composition is used for the precoating method.

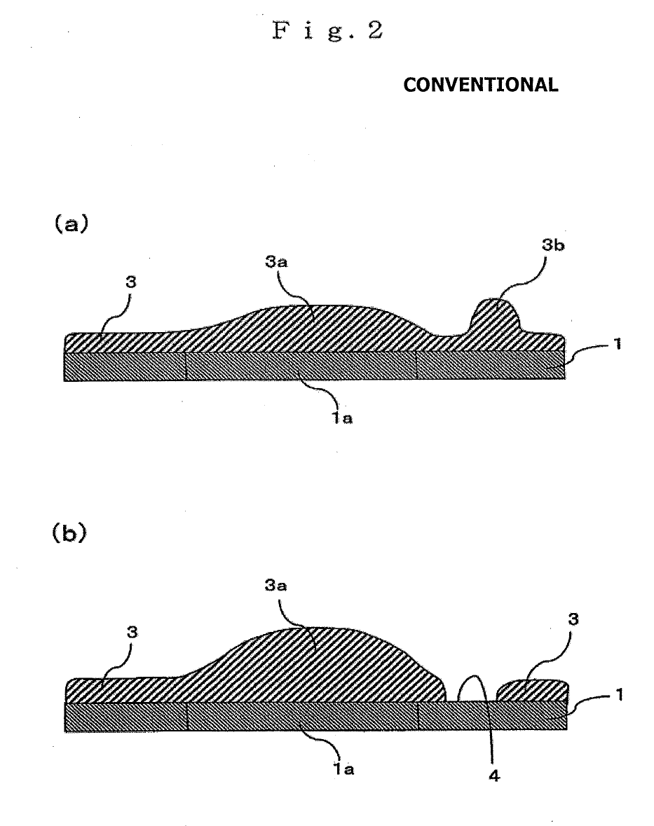

FIG. 3 is a partially enlarged sectional view of a mounted substrate for describing the conventional problems when an under-fill resin is supplied after the flip-chip connection.

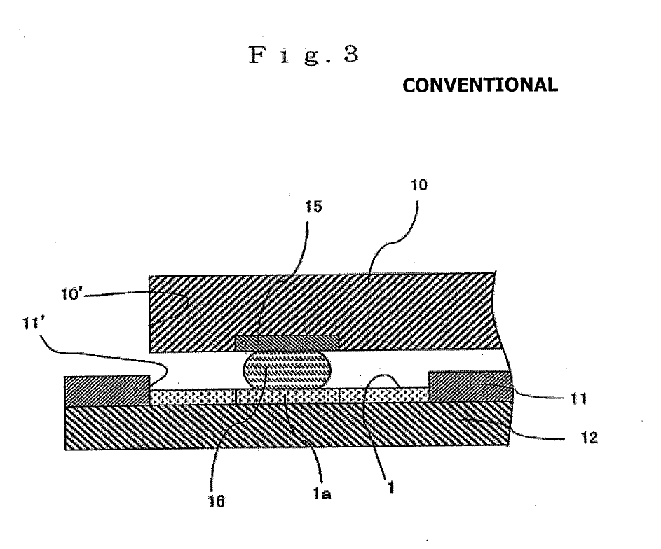

FIG. 4 is a partially enlarged sectional view of a mounted substrate according to one embodiment of the present invention.

FIG. 5 is a partially enlarged sectional view showing a state where the mounted substrate shown in FIG. 4 is filled with the under-fill resin.

FIG. 6 is a schematic plan view for describing a shape of a pad in the mounted substrate according to one embodiment of the present invention.

FIG. 7 is a schematic plan view for describing a shape of a pad in a mounted substrate according to another embodiment of the present invention.

FIG. 8 is a schematic plan view for describing a shape of a pad in a mounted substrate according to still another embodiment of the present invention.

FIG. 9 is a schematic sectional view illustrating the mounted substrate according to one embodiment of the present invention.

FIG. 10 shows a plan view and a sectional view for describing a process for manufacturing the mounted substrate shown in FIG. 9.

FIG. 11 shows a plan view and a sectional view for describing the process for manufacturing the mounted substrate shown in FIG. 9.

FIG. 12 shows a plan view and a sectional view for describing the process for manufacturing the mounted substrate shown in FIG. 9.

FIG. 13 shows a plan view and a sectional view for describing the process for manufacturing the mounted substrate shown in FIG. 9.

FIG. 14 shows a plan view and a sectional view for describing the process for manufacturing the mounted substrate shown in FIG. 9.

### DETAILED DESCRIPTION OF THE PREFERRED EMBODIMENTS

Hereinafter, preferred embodiments of the present invention are described in detail referring to the drawings.

### Solder Paste Composition

A solder paste composition according to the present invention is used for precoating a surface of an electrode with solder. More specifically, when the solder paste composition according to the present invention is evenly applied onto an electronic circuit substrate and the substrate to which the solder paste composition is evenly applied is heated, the melted solder is attached to the electrode of the substrate so that the electrode is precoated therewith.

For example, in the case of a screen mask used for printing the solder paste composition in screen printing or the like, a screen mask having an opening in a broad range including a plurality of electrodes is used in place of a screen mask having an opening by each electrode on the electronic circuit substrate. More specifically, in the case of the quad flat package (QFP), the screen mask having the opening is used along with shapes of respective sides of the QFP in which a plurality of electrodes are aligned at small pitches or along with a shape of the entire QFP including the sides. Then, the solder paste composition is evenly and roughly applied to a broad range including a large number of electrodes aligned per a small pitch irrespective of the position and shape of each electrode.

A first solder paste composition according to the present invention includes a solder powder and a flux. A second solder paste composition according to the present invention includes a deposition solder material and a flux.

The first solder paste composition according to the present invention is described below.

In the first solder paste composition according to the present invention, the solder powder may be a powder obtained from solder alloy (solder alloy powder) or a powder obtained from metallic tin (metallic tin powder). Further, the solder alloy powder and the metallic tin powder may be used together as the solder powder.

As the composition of the solder alloy powder, conventionally known various solder alloy powders can be adopted. Examples are solder alloy powders such as Sn (tin)-Pb (lead) based, Sn—Ag (silver) based, and Sn—Cu (copper) based alloy powder, and non-lead solder alloy powders such as Sn—Ag—In (indium) based, Sn—Ag—Bi (bismuth) based, and Sn—Ag—Cu based alloy powders. Of these examples, anon-lead solder alloy powder which does not include lead (lead-free), in particular, is preferable. Further, any of these examples may be solely used, or two or more of the different solder alloy powders may be used together. For example, the Sn—Ag—In based powder and the Sn—Ag—Bi based powder may be blended and used as the Sn—Ag—In—Bi based powder.

For example, it is preferred that the Sn—Ag based solder alloy powder preferably includes Ag in an amount of 0.5 to 5.0% by weight in its composition and includes Sn in the remnant. Further, in the case where any component other than Sn and Ag (In, Bi, Cu or the like) is added to the Sn—Ag based solder alloy powder whenever necessary, an amount of the component to be added is preferably in an amount of 0.1 to 15% by weight.

The metallic tin powder is powder in which tin is included by 100% by weight. When the metallic tin powder is used, types of intermetallic compounds formed in a bonding section is reduced when a terminal of an electronic component (Au stud bump or the like) is bonded in comparison to the case where, for example, the solder alloy powder is used. Therefore, such advantages as a superior mechanical properties or the like in the bonding section and giving the bonding with higher reliability.

An average particle diameter of the solder powder in the first solder paste composition according to the present invention is 0.5 to 30 μm, and preferably 1 to 10 μm regardless of if the solder alloy powder or the metallic tin powder is used. In the specification of the present invention, the average particle diameter denotes a value obtained by a particle distribution measuring device.

The flux generally includes base resin, a solvent, a thixotropic agent, and the like.

Examples of the base resin are rosin, acrylic resin, and the like. Only a type of resin may be used, and two or more types of base resins may be used together. For example, the rosin and acrylic resin may be mixed and used. A content of the base resin is 0.5 to 80% by weight, and preferably 20 to 80% by weight based on a total amount of the flux.

As the rosin may be used rosin conventionally used for the use of a flux and derivatives thereof. More specifically, examples include gum rosin, tall oil rosin and wood rosin, which are conventionally used. Examples of derivatives thereof include heat-treated resin, polymerized rosin, hydrogenated rosin, formylated rosin, rosin ester, rosin-modified maleic acid resin, rosin-modified phenol resin, rosin-modified alkyd resin, and the like. A class of the rosin is not particularly limited, and the WW class, for example, is preferably used.

A molecular weight of the acrylic resin is 30,000 or less, preferably 10,000 or less, and more preferably 3,000 to 8,000. When the acrylic resin has a molecular weight exceeding 30,000, there is a fear that cracking resistance and peeling resistance may deteriorate. Further, an acid value is preferably 30 or more in order to improve an active effect. Further, a softening point is preferably 230° C. or less because it is necessary for the substance to be softened in the soldering process. Therefore, a monomer having a polymerizing unsaturated group, such as (meta) acrylic acid, various esters thereof, crotonic acid, itaconic acid, maleic acid (anhydride) and various esters thereof, (meta) acrylonitrile, (meta) acrylamide, vinyl chloride, vinyl acetate, or the like, is used, and acrylic resin polymerized with a catalyst such as peroxide by means of the radical polymerization, such as bulk polymerization, solution polymerization, suspension polymerization, or emulsion polymerization, is preferably used.

The solvent is not particularly limited. Examples of the usable solvent are such solvents conventionally used for the flux as hexycarbitol, butylcarbitol, octylcarbitol, and mineral spirit. In order to attach the solder evenly to the surface of the electrode, the solvent having a specific gravity more than 1 is preferably used. Specific examples of the solvent having a specific gravity of more than 1 are: glycols such as ethylene glycol, diethylene glycol, triethylene glycol, propylene glycol, phenyl glycol, benzyl glycol, phenylpropylene glycol, and 1,3-butyleneglycol; carbitols such as methylcarbitol, phenylcarbitol and benzylcarbitol; other glycol ethers such as pentaethylene glycol monobutyl ether, ethylene glycol monophenyl ether (phenylcellosolve), triethylene glycol monomethyl ether, and propylene glycol phenyl ether; phthalic acid esters such as phthalic acid dimethyl, and phthalic acid diethyl, phthalic acid dibutyl; maleic acid esters such as maleic acid dimethyl and maleic acid diethyl; 2-pyrolidones such as N-methyl-2-pyrolidone, and the like. Of these substances, any substance having a boiling point of 180 to 350° C., preferably about 220 to 320° C., is preferably used. Only one type of solvent may be used, and two or more different solvents may be used together. An amount of the solvent to be included is 5 to 50% by weight, preferably 10 to 30% by weight based on the total amount of the flux.

Examples of the thixotropic agent include cured castor oil, hydrogenated castor oil, beeswax, and carnauba wax, and the like. An amount of the thixotropic agent to be included is preferably 1 to 50% by weight based on the total mount of the flux.

The flux may further include an activator whenever necessary. Examples of the activator include halogenated hydroacid salts of amines such as ethylamine, propylamine, diethylamine, triethylamine, ethylenediamine and aniline; organic carboxylic acids such as lactic acid, citric acid, stearic acid, adipic acid, diphenyl acetic acid, and benzoic acid. A content of the activator is 0.1 to 30% by weight based on the total amount of the flux.

In the flux, synthetic resins such as polyester resin, phenoxy resin and terpene resin and the like can be used together as the base resin of the flux. Further, to the flux, additives such as an antioxidant, a mildew proof agent and a delustering agent can be also added.

A weight proportion between the solder powder and the flux (solder powder:flux) is not particularly limited, however, is preferably approximately 70:30 to 20:80.

It is important for the first solder paste composition according to the present invention to include the metallic powder of the metallic species different from a metallic species constituting the solder powder and the metallic species constituting the electrode surface (hereinafter, maybe referred to as “metallic powder of different species”). When such a metallic powder of different species is included, it can be avoided to generate the variability in the height of the solder, any swollen portion and solder-lacking portion in precoating the electronic circuit substrate with the solder evenly applied thereto. It is assumed that such an effect can be obtained because the formation of the intermetallic compounds in the joint interface is controlled when the metallic powder of different species is added, and as a result, the deterioration of the fluidity of the solder during heating is thereby prevented.

The metallic powder of different species is not particularly limited as far as it is obtained from the metallic species different from the metallic species constituting the solder powder and the metallic species constituting the electrode surface. Depending on a type of the electrode to which the solder paste composition according to the present invention is applied and the type of the solder powder used therein, the metallic powder of different species may be suitable selected from any of examples such as Ni, Pd, Pt, Au, Co, Zn and the like. In the case where the electrode is a Cu electrode, for example, the metallic powder of different species is preferably at least one selected from the group consisting of Ni, Pd, Pt, Au, Co and Zn.

An average particle diameter of the metallic powder of different species is not particularly limited, however, is generally 0.01 to 10 μm, and preferably 0.1 to 3 μm. When the average particle diameter of the metallic powder of different species is too small, the wettability of the solder may be adversely affected. When the average particle diameter of the metallic powder of different species is too large, on the contrary, the height of the solder is likely to be variable. The average particle diameter of the metallic powder of different species is approximately 0.001 to 5 times, and preferably 0.01 to 1 times as large as the average particle diameter of the solder powder. When the average particle diameter of the metallic powder of different species is too large in comparison to that of the solder powder, uniform precoating is likely to be inhibited.

A content of the metallic powder of different species is 0.1% by weight or more and 20% by weight or less based on the total amount of the solder powder, and preferably 0.2% by weight or more and 8% by weight or less, and more preferably 0.8% by weight or more and 5% by weight or less. When the content of the metallic powder of different species to be included is less than the above-described ranges, the effect according to the present invention cannot be satisfactorily obtained. On the other hand, when the content of the metallic powder of different species is more than the above-described ranges, there is a tendency that the solder luster is deteriorated, and the increase of the amount to be added does not necessarily lead to the improvement of the effect.

The second solder paste composition according to the present invention will be then described.

In the second solder paste composition according to the present invention, the “solder powder” in the first solder paste composition according to the present invention is replaced with a “deposition solder material”. More specifically, the second solder paste composition according to the present invention includes the deposition solder material which deposits the solder by heating and the flux. The solder paste composition thus constituted is generally called a deposition solder paste composition (solder precipitating composition).

The deposition solder paste composition includes, for example, tin powder, lead salt of an organic acid, and the like. When such a composition is heated, lead atoms of the lead salt of the organic acid are substituted with tin atoms, and the lead atoms are isolated and dispersed into an excessive tin metallic powder, and Sn—Pb alloy is thereby formed. The deposition solder material deposits the solder when heated, and for example, the combination of the tin powder and the salt of metal or complex corresponds thereto. When the deposition solder paste composition is used, the solder can be accurately formed on the electrode despite fine pitches, and the generation of voids can be controlled.

More specifically, the deposition solder material preferably includes (a) tin powder and the slat of metal selected from lead, copper and silver, or (b) tin powder and complex of at least one selected from silver ion and copper ion and at least one selected from arylphosphines, alkylphosphines and azoles. The metallic salt in (a) and the complex in (b) may be combined with the tin powder. The “tin powder” includes the metallic tin powder, and for example, tin-silver based tin alloy powder including silver, tin-copper based tin alloy powder including copper, and the like. A proportion between the tin powder and a salt or a complex of metal (weight of tin powder : weight of a salt and/or a complex of metal) is approximately 99:1 to 50:50, and preferably approximately 97:3 to 60:40.

Examples of the salt of metal include organic carboxylate, organic sulfonate, and the like.

As the organic carboxylic acid in the organic carboxylate, monocarboxylic acid and dicarboxylic acid having 1 to 40 carbon atoms can be used. More specific examples are: lower fatty acids such as formic acid, acetic acid, and propionic acid; fatty acids obtained from animal and vegetable fats and oils such as caproic acid, caprylic acid, lauric acid, myristic acid, palmitic acid, stearic acid, oleic acid and linoleic acid; various synthesized acids obtained through organic synthesizing reactions such as 2,2-dimethylpentanoic acid, 2-ethylhexanoic acid, isononanoic acid, 2,2-dimethyloctane acid, and n-undecanoic acid; resin acids such as pimaric acid, abietic acid, dehydroabietic acid and dihydorabietic acid; monocarboxylic acid obtained from petroleum such as naphthenic acid; dimmer acid synthesized from tall oil fatty acid or soybean fatty acid; and dicarboxylic acid such as polymerized rosin in which rosin is dimerized, and two or more of these substances may be included.

Examples of the organic sulfonic acid in the organic sulfonate include methanesulfonic acid, 2-hydroxyethane sulfonic acid, 2-hydroxypropane-l-sulfonic acid, trichloromethane sulfonic acid, trifluoromethane sulfonic acid, benzene sulfonic acid, toluene sulfonic acid, phenol sulfonic acid, creosol sulfonic acid, anisole sulfonic acid, naphthalene sulfonic acid, and the like, and two or more of these substances may be included.

A specific example of the complex of silver and copper is a complex of silver ions and/or copper ions and at least one selected from aryl phosphines, alkyl phosphines and azoles.

Examples of the phosphines which are suitably used include aryl phosphines such as triphenyl phosphine, tri (o-, m-, or p-tolyl)phosphine and tri(p-methoxyphenyl)phosphine, tributyl phosphine, trioctylphosphine, tris(3-hydroxypropyl)phosphine, tribenzyl phosphine, and the like.

The complex obtained from the aryl phosphines and the alkyl phosphines are cationic, therefore, counter anion is necessary. Suitable examples of the counter anion are organic sulfonic acid ion, organic carboxylic ion, halogen ion, nitric acid ion, and sulfuric acid ion. Any of these substances can be used alone, and two or more of them can be used together.

Suitable examples of the organic sulfonic acid used as the counter anion include methane sulfonic acid, toluene sulfonic acid, phenol sulfonic acid, and the like. Suitable examples of the organic carboxylic acid used as the counter anion include formic acid, acetic acid, oxalic acid, lactic acid, trichloroacetic acid, trifluoroacetic acid, and perfluoropropaonic acid, and acetic acid, lactic acid, trifluoroacetic acid and the like are particular suitably used.

Examples of the azoles include tetrazole, triazole, benzotriazole, imidazole, benzimidazole, pyrazole, indazole, triazole, benzothiazole, oxazole, benzoxazole, pyrrole, and indole, and these derivatives. And one or two or more of them may be mixed and used. Of these substances, 5-mercapto-1-phenyltetrazol, 3-mercapto-1,2,4-triazole, benzotriazole, tolyltriazole, carboxybenzotriazole, imidazole, benzimidazole, 2-octylbenzimidazole, 2-mercaptobenzimidazole, benzothiazole, 2-mercaptobenzothiazole, benzoxazole, 2-mercaptobenzoxazole, and the like, are suitably used.

The second solder paste composition according to the present invention is similar to the first solder paste composition according to the present invention except that the “deposition solder material” is used. Therefore, the description relating to the first solder paste composition according to the present invention is applicable when the “solder powder” recited therein is replaced with a “deposition solder material”. For example, the second solder paste composition is similar to the first solder paste composition in that at least one selected from the group consisting of Ni, Pd, Pt, Au, Co and Zn is preferably used as the metallic powder of the different species in the case where the electrode is the Cu electrode.

However, in relation to the metallic powder of different species and the amount thereof to be included, the metallic powder of the metallic species different from the metallic species constituting the metallic component in the deposition solder material and the metallic species constituting the electrode surface is used as the metallic powder of different species in the second solder paste composition according to the present invention, and the metallic powder of different species is included by 0.1% by weight or more and 20% by weight or less based on the total amount of the metallic component included in the deposition solder material (preferable range and more preferable range are the same as those in the first solder paste composition). That is, in the description of the metallic powder of different species, the “solder powder” in the description of the first solder paste composition is simply replaced with the “metallic component included in the deposition solder material”.

The solder obtained from the solder paste composition according to the present invention does not generate any swollen portion or solder-lacking portion, and the height thereof is generally approximately 10 to 20 μm, which is substantially constant. When the solder paste composition according to the present invention is used, the solder can be provided with narrow pitches, and further, with pitches of approximately 70 μm or less.

### Solder Precoating Method

In a solder precoating method according to the present invention, the solder paste composition according to the present invention is applied onto an electronic circuit substrate provided with a pad having a large-width section whose width is larger than other portions in a part thereof in a longitudinal direction and then heated, so that a surface of an electrode provided in the large-width section of the pad is precoated with the solder. According to the solder precoating method, the solder can be easily formed in such a manner that any swollen portion and solder-lacking portion are not generated and the height is rarely variable. More specifically, the solder can be formed in the hump shape in such a manner that any swollen portion is not generated in any part other than the large-width section of the pad, any solder-lacking portion is not generated in a part of the solder, and the variability of the height of the solder is not generated in a plurality of large-width sections.

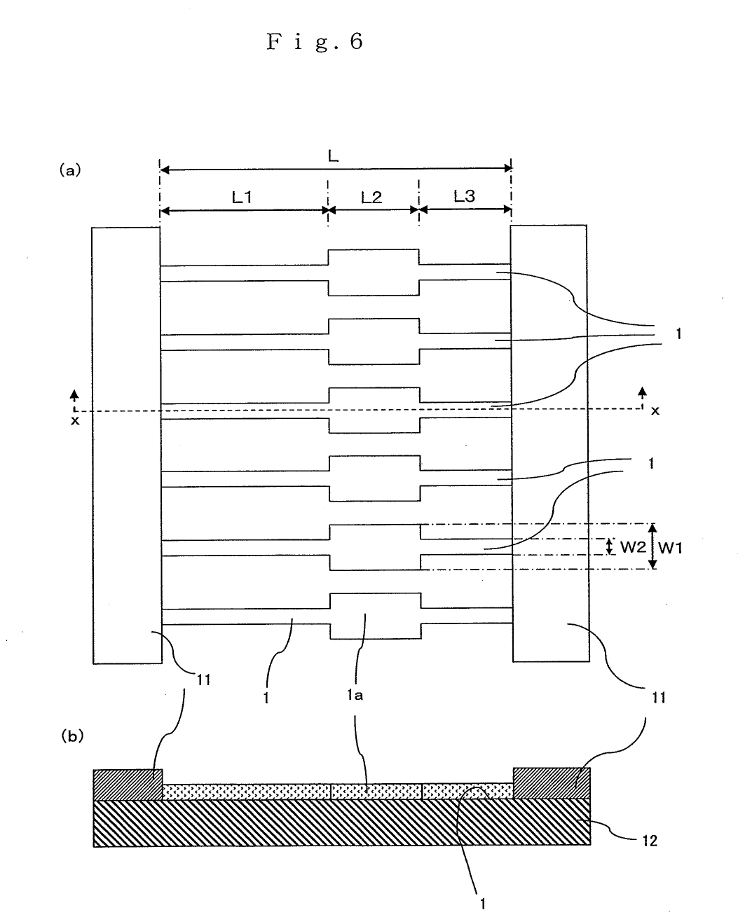

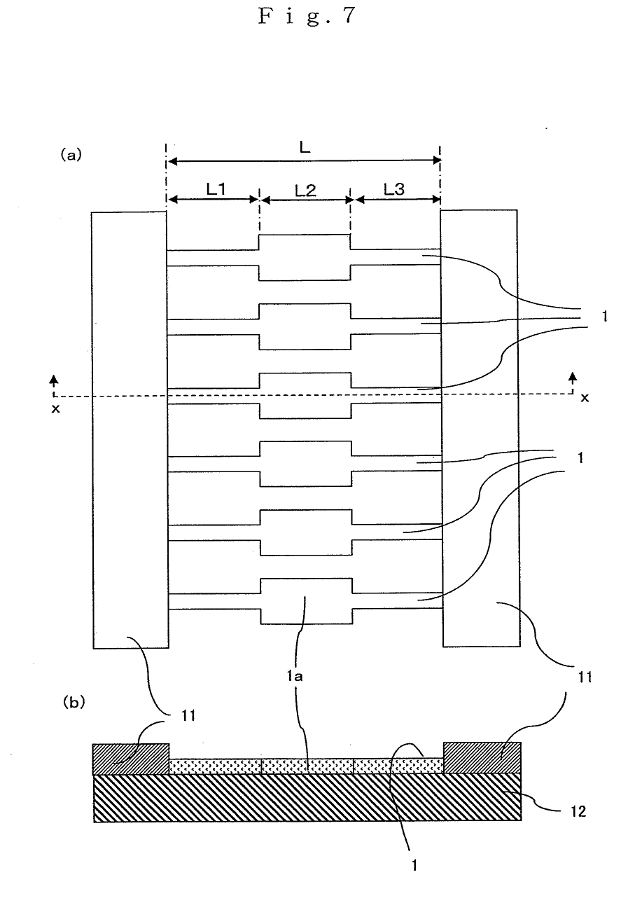

In the precoating method according to the present invention, the pad 1 is preferably shaped as shown in FIG. 7 so that the large-width section 1a is positioned at substantially the center in the longitudinal direction in order to form the solder having the hump shape can be favorably formed in the large-width section 1a. However, the pad 1 is preferably shaped so that a length (L1) from one end in the longitudinal direction to the large-width section 1a and a length (L3) from the other end to the large-width section 1a are different from each other as shown in FIG. 6 in order to more effectively fill the under-fill resin into between the electronic circuit substrate and the semiconductor chip after they are flip-chip-connected to each other.

In the case of the pad having the shape shown in FIG. 6, it was conventionally difficult to form the favorable solder having the hump shape in the large-width section 1a. In the precoating method according to the present invention, however, the favorable solder having the hump shape can be formed in the large-width section 1a even on the pad having the shape shown in FIG. 6 when the solder paste composition according to the present invention is used.

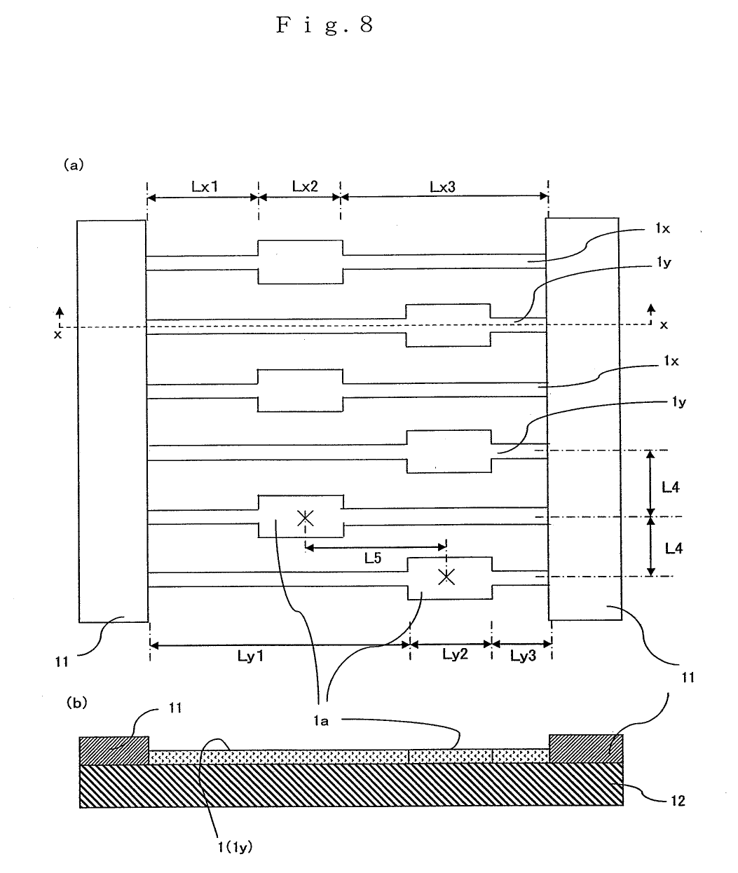

All of a plurality of pads 1 provided on an electronic circuit substrate 12 may have the same shape, or two different pads 1x and 1y, which have the large-width sections 1a at different positions, may be alternately provided as shown in FIG. 8. In that case, specific dimensions of the respective sections in FIG. 8 are, for example: Lx1: approximately 86 μm, Lx2: approximately 50 μm, Lx3: approximately 164 μm, Ly1: approximately 190 μm, Ly2: approximately 50 μm, Ly3: approximately 60 μm, L4 (interval between pad 1x and pad 1y): approximately 40 μm, and L5 (interval between the center of large-width section 1a of pad 1x and the center of large-width section 1a of pad 1y): approximately 104 μm.

In FIGS. 6 to 8, (a) is a plan view showing a plurality of pads provided on the electronic circuit substrate, and (b) is a sectional view cut along an x-x sectional surface.

More specifically describing the precoating method according to the present invention, the solder paste composition according to the present invention is evenly applied onto the substrate by means of the screen printing or the like, and the substrate is thereafter preheated at, for example, 150 to 200° C. and reflowed at an maximum temperature of approximately 170 to 280° C. The application and the reflow of the solder with respect to the substrate may be performed in the atmosphere, or may be performed in the inert atmosphere of N₂, Ar, He or the like.

According to the precoating method according to the present invention, the solder paste composition according to the present invention is applied to the electronic circuit substrate provided with the pad having the large-width section whose width is larger than the other portions in a part thereof in the longitudinal direction. However, the solder paste composition according to the present invention is not limited thereto, and may be applied to an electronic circuit substrate provided with a pad having an equal width in the longitudinal direction (band shape with no large-width section).

### Mounted Substrate

In a mounted substrate according to the present invention, an electronic component mounted on an electronic circuit substrate is thermally compression-bonded thereto by the precoating solder in which the solder paste composition according to the present invention is used. The solder used in the mounted substrate according to the present invention is preferably formed by means of the precoating method of the present invention described above.

It is preferable that an insulation film having an opening and a plurality of pads provided in the opening be formed on a main surface of the electronic circuit substrate, the pads each has the large-width section having a width larger than the other portions in a part thereof in the longitudinal direction, and electrodes provided in the large-width sections and electrodes provided on the main surface of the electronic component be flip-chip-connected by the solder.

Further, the pad is preferably shaped so that the length from one end in the longitudinal direction to the large-width section and the length from the other end to the large-width section are different from each other, and an end portion on the side with the larger length to the large-width section is positioned on an outer side of the substrate than an end portion of the electronic component.

The under-fill resin is preferably filled into between the electronic circuit substrate and the electronic component.

Hereinafter, preferred embodiments of the mounted substrate according to the present invention will be described referring to the drawings.

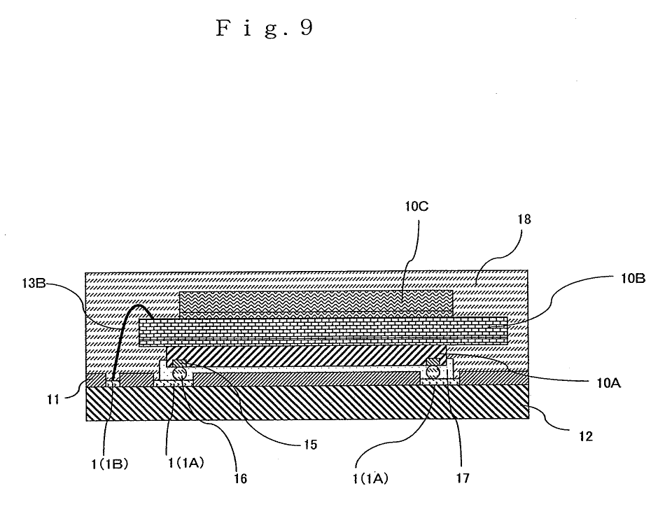

FIG. 9 is a schematic sectional view of a semiconductor device (mounted substrate) provided with a plurality of electronic components (semiconductor chips) in piles on an electronic circuit substrate 12. In the semiconductor device, a semiconductor chip (microcomputer chip) 10A, which is a first electronic component, is flip-chip-connected via a bump 16 by the solder precoating the electronic circuit substrate 12 in which the solder paste composition according to the present invention is used. A semiconductor chip (DDR2-SDRAM) 10B, which is a second electronic component, is mounted on the semiconductor chip 10A by means of the wire-bond connection in which a wire 13B is used. Further, a semiconductor chip (SDRAM) 10C, which is a third electronic component, is mounted further thereon by means of the wire-bond connection in which a wire (13C) is used. Then, a periphery of the mounted first, second and third electronic components is covered with a mold resin 18.

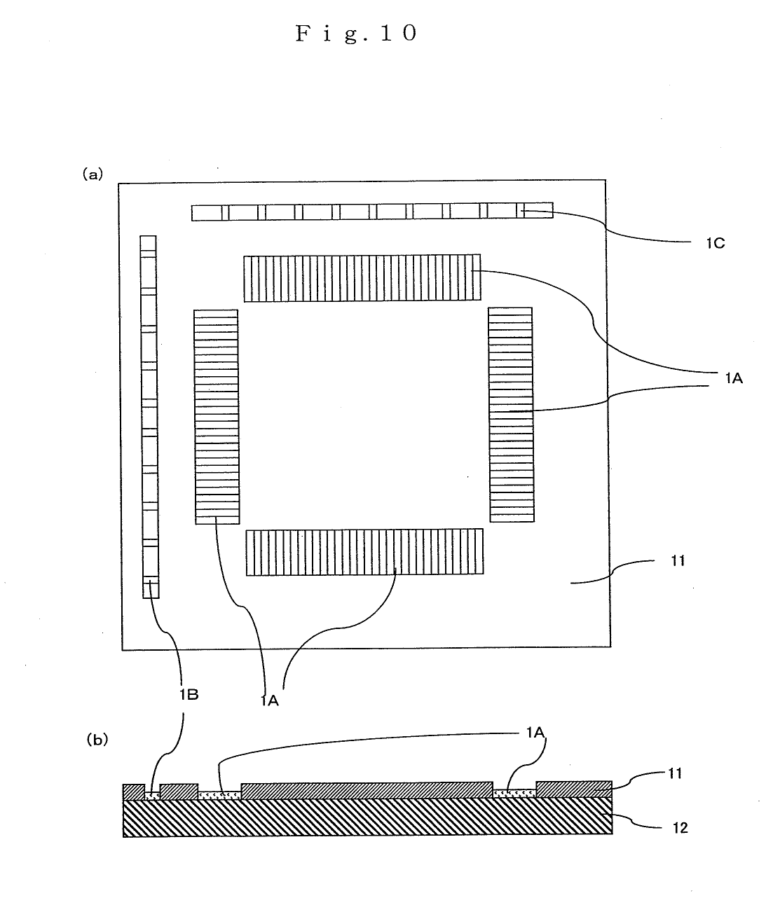

The mounted substrate according to the present preferred embodiment can be manufactured in processes shown in FIGS. 10 to 14. In FIGS. 10 to 14, (a) is a schematic plan view showing states in the respective processes, and (b) is a sectional view showing the same.

On a main surface of the electronic circuit substrate 12 according to the preferred embodiment is formed an insulation film (solder resist) 11 having a plurality of openings as shown in FIG. 10, and a plurality of pads 1A, 1B and 1C are formed in the respective openings. The pad 1A is precoated with the solder paste composition so that the first electronic component is connected thereto, the second electronic component is connected to the pad 1B via the wire 13B, and the third electronic component is connected to the pad 1C via the wire 13C.

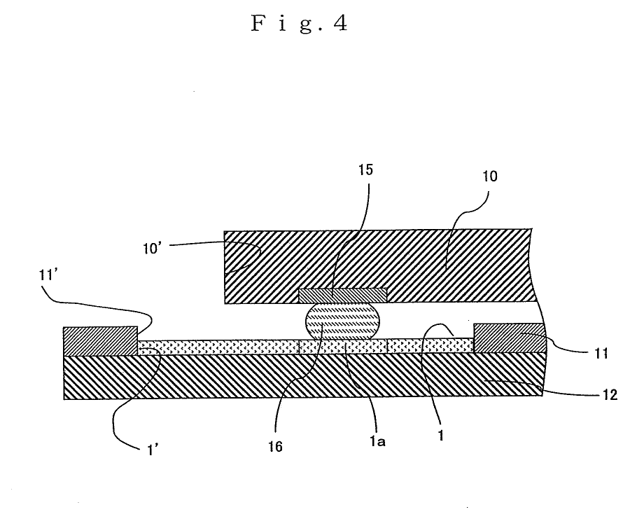

As shown in FIG. 6, the pad 1A, more specifically, has a large-width section 1a whose width is larger than other portions in a part thereof in a longitudinal direction, wherein a length from one end in the longitudinal direction to the large-width section 1a (L1) and a length from the other end to the large-width section (L3) are different from each other. As shown in FIG. 4, in this pad 1A, an end portion 1′ on the side with the larger length to the large-width section 1a is provided at a position on an outer side of the substrate than an end portion 10′ of the electronic component.

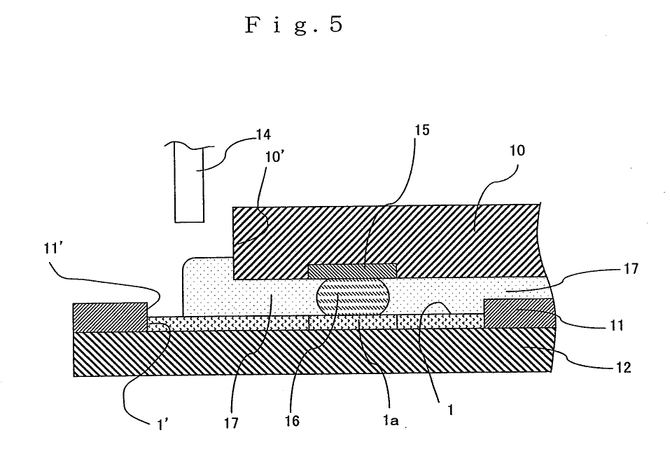

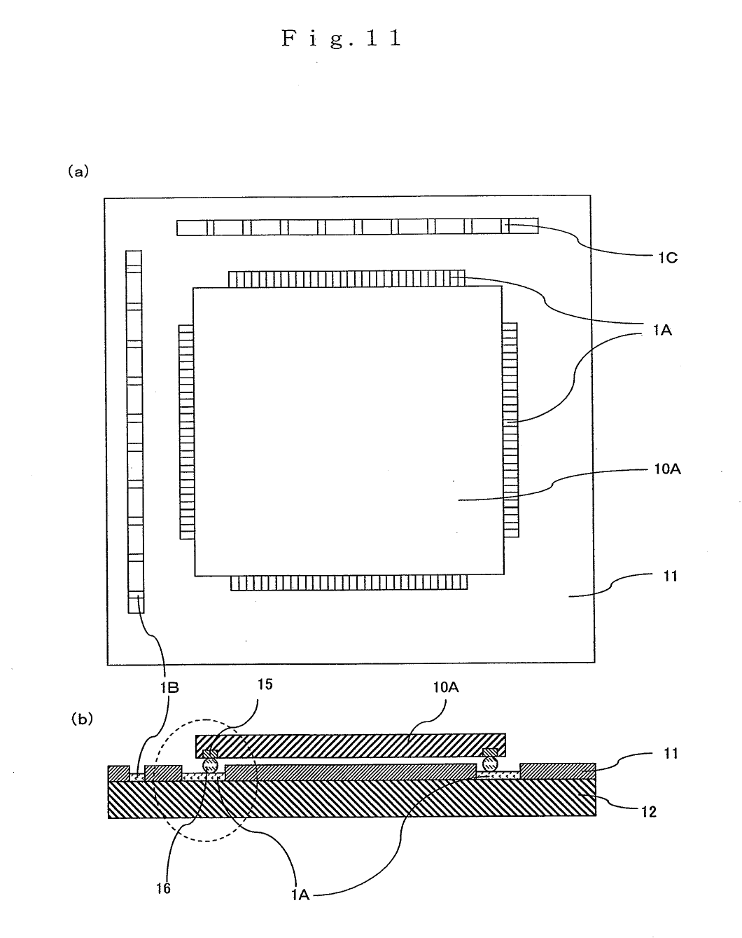

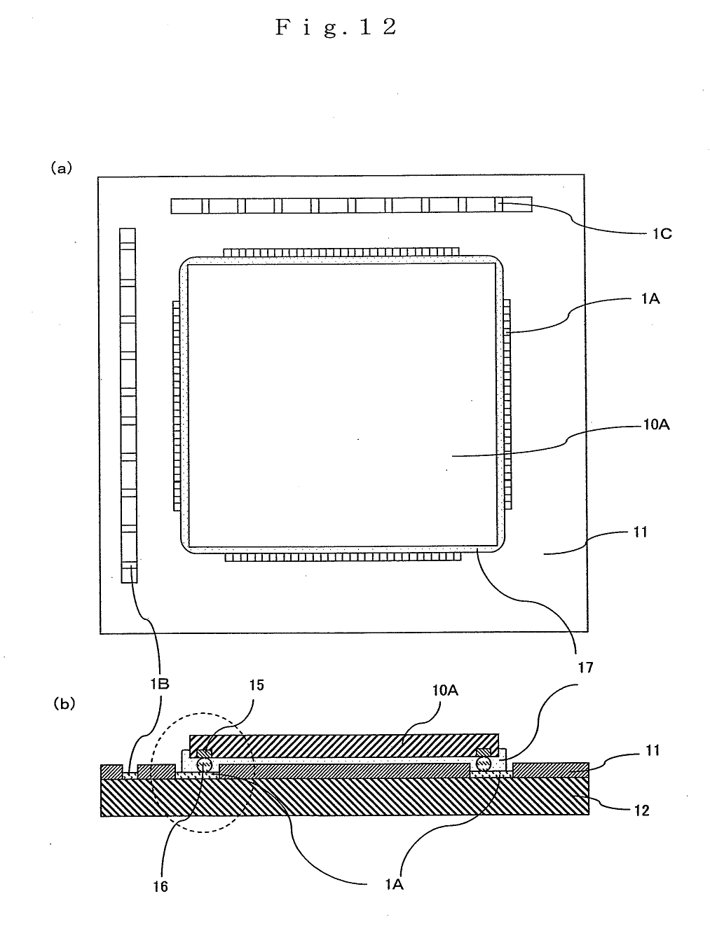

In this manner, the pad 1A having the particular shape is provided at a particular position so that a resin inlet can be enlarged in a region where a supply nozzle 14 for under-fill resin is moved as shown in FIG. 5 so that the filling of the under-fill resin can be more effectively performed when the resin is supplied as described later. Further, it was conventionally often difficult to form the favorable solder having the hump shape in the large-width section in the case where the pad has the shape shown in FIG. 6 (the length from one end in the longitudinal direction to the large-width section and the length from the other end to the large-width section are different from each other). According to the present invention, however, such a shape of the pad allows the formation of the solder having the hump shape in the large-width section without any swollen portion, solder-lacking portion, and variability in the height of the solder. FIG. 4 is an enlarged sectional view of a main part (part surrounded by a dashed line) shown in FIG. 11(b) illustrating the process in which the semiconductor chip 10A, which is the first electronic component, is mounted on the electronic circuit substrate 12 by means of the flip-chip connection. FIG. 5 is an enlarged sectional view of a main part (part surrounded by a dashed line) shown in FIG. 12(b) illustrating the process in which the under-fill resin is supplied.

The shapes and the like of the pads 1B and 1C are not particularly limited as far as the conventionally known wire-bond connection is applicable thereto. The electronic circuit substrate 12 is not particularly limited, and any electronic circuit substrate conventionally applied to the semiconductor device can be used. On a rear side of the main surface of the electronic circuit substrate 12 are provided solder balls (not shown) for electrically connecting the circuit substrate to a wiring conductor of an external electric circuit substrate.

The solder having the hump shape is formed on the large-width section 1a of the pad 1A of the electronic circuit substrate 12 by means of the solder precoating method according to the present invention. Then, the semiconductor chip 10A, which is the first electronic component, is positioned and mounted so that the main surface of the semiconductor chip 10A faces the main surface of the electronic circuit substrate 12 and the solder having the hump shape and the bump 16 provided on the electrode 15 of the semiconductor chip are consistent with each other. Thus, the electrode (not shown) provided in the large-width section 1a and the electrode 15 provided on the main surface of the electronic component are flip-chip-connected by the solder.

After the electronic circuit substrate 12 and the semiconductor chip 10A as the first electronic component are flip-chip-connected, the under-fill resin 17 is filled into between the electronic circuit substrate 12 and the semiconductor chip 10A as shown in FIG. 12. By filling the under-fill resin 17 thereinto, the part where the electronic circuit substrate 12 and the semiconductor chip 10A join with each other can be prevented from separating away. The under-fill resin 17 is not particularly limited, and any resin which is conventionally used for the purpose can be applied. The under-fill resin 17 may include a filler, or the like, whenever necessary. As described above, according to the present preferred embodiment, the under-fill resin can be effectively supplied.

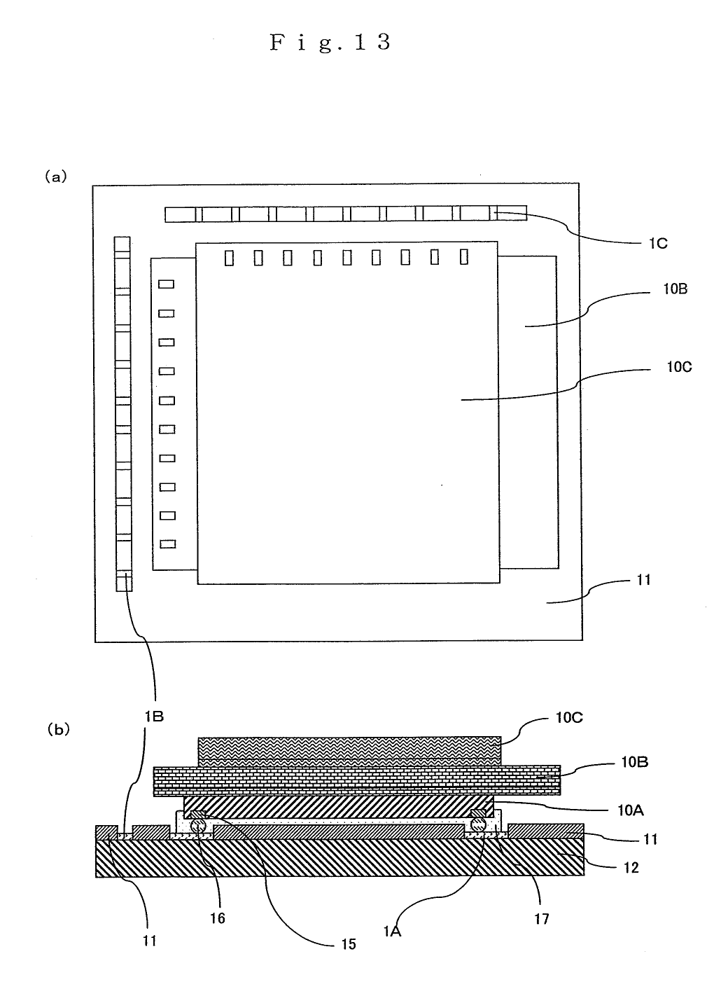

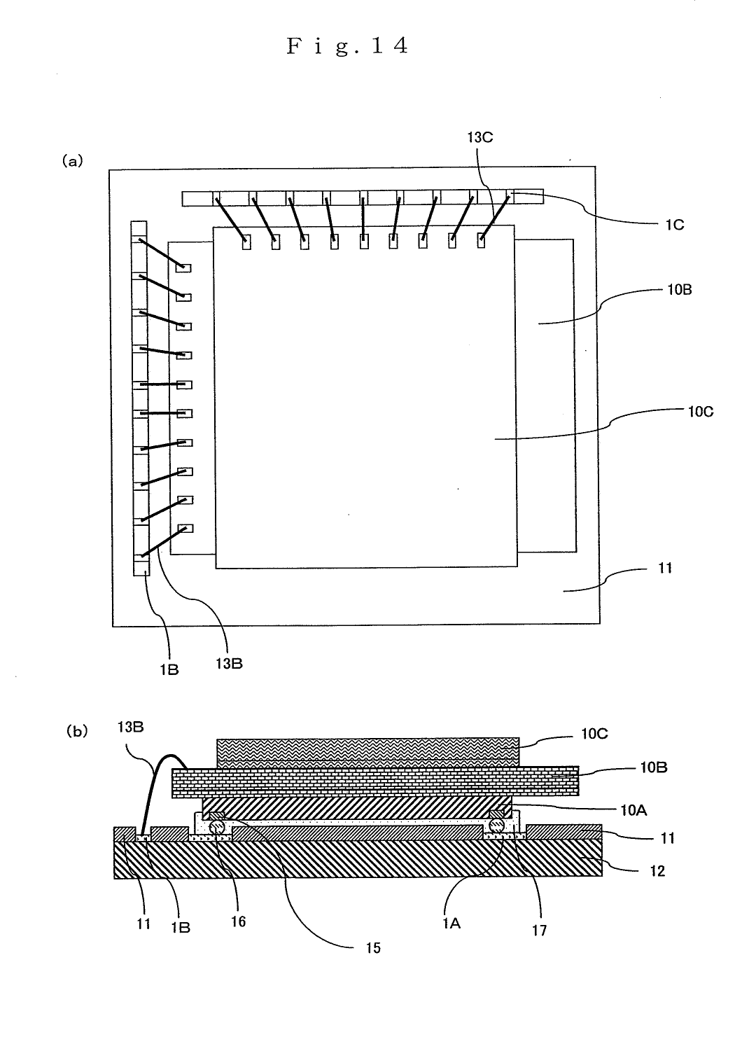

After the supply of the under-fill resin, as sown in FIG. 13, the semiconductor chip 10B as the second electronic component and the semiconductor chip 10C as the third electronic component are sequentially layered on the first electronic component 10A. Then, as shown in FIG. 14, the pad 1B and the semiconductor chip 10B as the second electronic component are connected to each other via the wire 13B, and the pad 1C and the semiconductor chip 10C as the third electronic component are connected to each other via the wire 13C. Thereafter, a periphery thereof is surrounded by a mold resin 18 by means of the conventional collective molding method, and as a result, the semiconductor device shown in FIG. 9 can be provided. The mold resin 18 is not particularly limited, and any resin which is conventionally used for the purpose can be applied.

The above embodiment relates to the piled mounted substrate provided with the second and third electronic components, however, the mounted substrate according to the present invention is not limited thereto. It is needless to say that the present embodiment can be applied to a mounted substrate in which only one electronic component is provided on the electronic circuit substrate.

The present invention is described in detail below referring to Examples.

### Examples

### Examples 1 to 10 and Comparative Examples 1 to 7

70 parts by weight of WW-class tall oil rosin, 20 parts by weight of benzylcarbitol (solvent; specific gravity of 1.08), and 10 parts by weight of a hydrogenated castor oil (thixotropic agent) were mixed, and the mixture was heated and melted at 120° C., and then cooled to room temperature so that a flux having a viscosity was prepared.

Among Sn—Ag based solder alloy powders in which Ag is included in an amount of 3.5% by weight (Sn-3.5 Ag) and metallic tin powders (Sn), 60 parts by weight of those shown in Table 1 as the solder powder, amounts of the metallic powder of the metallic species shown in Table 1 as the metallic powder of the different species (not added in Comparative Examples 1 and 7), and 40 parts by weight of the flux prepared as described above were kneaded by a conditioning mixer (“Awatori Rentaro” (Hybrid Deforming Mixer) manufactured by THINKY CORPORATION) so that solder paste compositions for the copper electrode were obtained.

TABLE 1

| | | Metallic | | |
|---|---|---|---|---|
| | Solder | species of | Amount of added metallic | |
| | powder | metallic | powder (based on total | |
| | species | powder | amount of solder powder) | |
| Example 1 | Sn—3.5Ag | Palladium | 0.3% | by weight |
| Example 2 | Sn—3.5Ag | Palladium | 1% | by weight |
| Example 3 | Sn—3.5Ag | Palladium | 5% | by weight |
| Example 4 | Sn—3.5Ag | Nickel | 0.3% | by weight |
| Example 5 | Sn—3.5Ag | Nickel | 1% | by weight |
| Example 6 | Sn—3.5Ag | Nickel | 5% | by weight |
| Example 7 | Sn—3.5Ag | Nickel | 10% | by weight |
| Example 8 | Sn—3.5Ag | Cobalt | 1% | by weight |
| Example 9 | Sn | Nickel | 0.5% | by weight |
| Example 10 | Sn | Nickel | 1% | by weight |
| Comparative | Sn—3.5Ag | Not added | 0% | by weight |
| Example 1 | | | | |
| Comparative | Sn—3.5Ag | Tin | 1% | by weight |
| Example 2 | | | | |
| Comparative | Sn—3.5Ag | Copper | 1% | by weight |
| Example 3 | | | | |
| Comparative | Sn—3.5Ag | Palladium | 0.01% | by weight |
| Example 4 | | | | |
| Comparative | Sn—3.5Ag | Silver | 1% | by weight |
| Example 5 | | | | |
| Comparative | Sn | Copper | 1% | by weight |
| Example 6 | | | | |
| Comparative | Sn | Not added | 0% | by weight |
| Example 7 | | | | |

The solder paste compositions thus obtained were respectively evaluated in terms of an average height, variability of the height, swollen portion and solder-lacking portion of the solder. Below are shown evaluation methods, and results of the evaluation are shown in Table 2.

### Average Height and Variability in Height of Solder

An electronic circuit substrate provided with pads each having a large-width section whose width is larger than other portions in a part thereof in a longitudinal direction and a length from one end in the longitudinal direction to the large-width section and a length from the other end to the large-width section are different from each other (pad 1 with W1: 30 μm, W2: 20 μm, L: 300 μm, L1: 200 μm, L2: 50 μm, and L3: 50 μm shown in FIG. 6) at 60 μm pitches was prepared. The respective solder paste compositions were evenly printed in the thickness of 100 μm on the copper electrodes provided on the large-width sections of the pads and peripheral solder resists thereof, and heated by a reflow profile in which a maximum temperature was 260° C. Then, the substrate was dipped in a supersonic cleaner where a butylcarbitol solution of 60° C. is fed, and flux residue was eliminated therefrom. After that, the height of the solder on the electrode were measured at 20 points by a focal depth gauge (manufactured by KEYENCE CORPORATION), and an average value obtained from the measured values was used as an “average height of the solder”. Then, a standard deviation thereof was calculated and used as a “variability of the height”.

### Swollen Portion and Solder-Lacking Portion

An outer appearance of the solder in the precoating state, which was obtained in the “average height and variability of the height of the solder” was observed by a microscope so that the presence or absence of the “swollen portion” and “solder-lacking portion” in the solder was confirmed.

TABLE 2

| | Average | | | |
|---|---|---|---|---|
| | height | | Swollen | |
| | of | Variability | portion | |
| | solder | of height | of solder | Solder-lacking |
| Example 1 | 18.5 μm | 1.2 | Absence | Absence |
| Example 2 | 16.8 μm | 1.3 | Absence | Absence |
| Example 3 | 18.2 μm | 1.4 | Absence | Absence |
| Example 4 | 18.1 μm | 1.2 | Absence | Absence |
| Example 5 | 17.8 μm | 1.5 | Absence | Absence |
| Example 6 | 17.2 μm | 1.4 | Absence | Absence |
| Example 7 | 16.2 μm | 1.9 | Absence | Absence |
| Example 8 | 17.5 μm | 1.4 | Absence | Absence |
| Example 9 | 18.5 μm | 1.5 | Absence | Absence |
| Example 10 | 17.9 μm | 1.3 | Absence | Absence |
| Comparative | 15.8 μm | 2.8 | Presence | Presence |
| Example 1 | | | | |
| Comparative | 16.4 μm | 3.0 | Presence | Presence |
| Example 2 | | | | |
| Comparative | 17.1 μm | 2.7 | Presence | Presence |
| Example 3 | | | | |
| Comparative | 16.6 μm | 2.9 | Presence | Presence |
| Example 4 | | | | |
| Comparative | 17.0 μm | 3.5 | Presence | Presence |
| Example 5 | | | | |
| Comparative | 17.5 μm | 2.5 | Presence | Presence |
| Example 6 | | | | |
| Comparative | 18.1 μm | 3.2 | Presence | Presence |
| Example 7 | | | | |

As is clear from Table 2, in the solders formed by the solder paste compositions in Examples 1 to 8 in which the solder alloy was used as the solder powder, the swollen and solder-lacking portions were not generated, and the variability of the height was small. The solder paste compositions in Examples 9 to 10 in which the metallic tin was used as the solder powder similarly obtained favorable results.

On the contrary, in the solders formed from the solder paste compositions including the solder alloy as the solder powder in Comparative Example 1 where the metallic powder of different species was not added, in Comparative Examples 2 and 5 where the tin powder and the silver powder of the same metallic species as that of the solder powder were added, in Comparative Example 3 where the copper powder of the same metallic species as that of the electrodes was added, and in Comparative Example 4 where the amount of the added metallic powder was too small, the variability in the height was large, and the swollen and solder-lacking portions were found. Further, in the solders formed from the solder paste compositions including the metallic tin as the solder powder in Comparative Example 6 where the copper powder of the same metallic species as that of the electrode was added and in Comparative Example 7 where the metallic powder was not added at all, the variability in the height was large, and the swollen and solder-lacking portions were found.

### Example 11

70 parts by weight of WW-class tall oil rosin, 25 parts by weight of benzylcarbitol (solvent; specific gravity of 1.08), and 5 parts by weight of a hydrogenated castor oil (thixotropic agent) were mixed, and the mixture was heated and melted at 120° C., and then cooled to room temperature so that a flux having a viscosity was prepared.

Then, a silver compound ([Ag{P (C₆H₅)₃}₄]+CH₃SO₃—; an amount of the silver included in the silver compound was 8% by weight) , and the flux prepared described above were evenly mixed at the proportion of 1:1 (weight proportion) by three rolls so that a flux including the silver compound was prepared. After that, 60 parts by weight of the tin powder, 40 parts by weight of the flux including which the silver compound, and 0.6 parts by weight of the metallic powder of palladium as the metallic powder of different species (corresponding to 1% by weight based on the tin powder) were mixed and kneaded by the conditioning mixer (“Awatori Rentaro” (Hybrid Deforming Mixer) manufactured by THINKY CORPORATION). As a result, a deposition solder paste composition for the copper electrode was obtained.

### Comparative Example 8

Deposition solder paste compositions were obtained in a manner similar to Example 11 other than that the metallic powder of palladium was not added in Example 11.

The solder paste compositions thus obtained were used so that the average height, height variability, swollen portion, and solder-lacking portion in the solder were evaluated according to a method similar to those in Examples 1 to 10 and comparative examples 1 to 7. Results are shown in Table 3.

TABLE 3

| | Average | | | |
|---|---|---|---|---|
| | height | | Swollen | |
| | of | Variability | portion | |
| | solder | of height | of solder | Solder-lacking |
| Example 11 | 18.1 μm | 1.3 | Absence | Absence |
| Comparative | 16.1 μm | 3.3 | Presence | Presence |
| Example 8 | | | | |

As is clear from Table 3, it can be learnt that the variability of the height was small, and any swollen and solder-lacking portions were not generated in the solder formed from the solder paste composition in Example 11. In contrast, the variability of the height was large, and the swollen and solder-lacking portions were generated in the solder formed from the solder paste composition in Comparative Example 8 in which the metallic powder was not added.

In the above description, preferred embodiments of the present invention were shown; however, the present invention is not limited to the preferred embodiments.

1-14. (canceled)

15. A solder precoating method comprising applying a solder paste composition onto an electronic circuit substrate provided with a pad having a large-width section having a larger width than other portions in a part thereof in a longitudinal direction, and thereafter heating so that a solder is precoated on a surface of an electrode provided in the large-width section of the pad, and
wherein the solder paste composition used for precoating a solder on a Cu electrode surface of an electronic circuit substrate provided with a pad having a large-width section having a larger width than other portions in a part thereof in a longitudinal direction, comprising
a solder powder comprising Sn—Ag based solder alloy or metallic tin and a flux, and
a metallic powder comprising at least one selected from the group consisting of Ni, Pd, Pt, Au, Co and Zn, which is metallic species different from both of metallic species constituting the solder powder and metallic species constituting the electrode surface, in a rate of 0.1% by weight or more and 20% by weight or less based on a total amount of the solder powder.

16. The precoating method according to claim 15, wherein the pad has a shape in which a length from one end in the longitudinal direction to the large-width section and a length from another end to the large-width section are different from each other.

17. The solder precoating method according to claim 15, wherein the solder paste composition is evenly applied onto a circuit substrate.

18. A solder precoating method, comprising applying a solder paste composition onto an electronic circuit substrate provided with a pad having a large-width section having a larger width than other portions in a part thereof in a longitudinal direction, and thereafter heating so that a solder is precoated on a surface of an electrode provided in the large-width section of the pad,
wherein the solder paste composition used for precoating a solder on a Cu electrode surface of an electronic circuit substrate provided with a pad having a large-width section having a larger width than other portions in a part thereof in a longitudinal direction, comprising
a deposition solder material for depositing the solder by heating, which comprises (i) tin powder and salt of metal selected from lead, copper and silver, or (ii) tin powder and a complex of at least one selected from silver ion and copper ion and at least one selected from arylphosphines, alkylphosphines and azoles, and a flux, and
a metallic powder comprising at least one selected from the group consisting of Ni, Pd, Pt, Au, Co and Zn, which is metallic species different from both of metallic species constituting a metallic component in the deposition solder material and metallic species constituting the electrode surface, in a rate of 0.1% by weight or more and 20% by weight or less based on a total amount of the metallic component in a deposition solder material.

19. The precoating method according to claim 18, wherein the pad has a shape in which a length from one end in the longitudinal direction to the large-width section and a length from another end to the large-width section are different from each other.

20. The solder precoating method according to claim 18, wherein the solder paste composition is evenly applied onto a circuit substrate.
